(19) United States
(12) Patent Application Publication
(10) Pub. No.: US 2024/0395096 A1
(43) Pub. Date: Nov. 28, 2024

(54) BANKNOTE COMPARTMENT MODULE AND BANKNOTE PROCESSING DEVICE

(71) Applicant: Giesecke+Devrient Currency Technology GmbH, Munich (DE)

(72) Inventors: Simranjeet BHAGAT, Munich (DE); Aashish BHATNAGAR, Munich (DE); Pulkit NIGAM, Munich (DE)

(21) Appl. No.: 18/668,330

(22) Filed: May 20, 2024

(30) Foreign Application Priority Data
May 24, 2023 (IN) 202311036040

(51) Int. Cl. G07D 11/40; B65H 31/00; G07D 11/18

(52) U.S. Cl. CPC G07D 11/40; B65H 31/00; G07D 11/18; B65H 2701/1912; G07D 2211/00

(57) ABSTRACT

The invention relates a banknote compartment module, includes a base unit having a support structure, a first banknote compartment coupled to the support structure and configured to receive a stack of banknotes, and a subunit coupled to the support structure and arranged adjacent the first banknote compartment. The subunit is movable with respect to the first banknote compartment between a first configuration and a second configuration. The first banknote compartment provides a first space dimension for receiving the stack of banknotes when the subunit is in the first configuration and provides a second space dimension for receiving the stack of banknotes when the subunit is in the second configuration. The first space dimension is greater than the second space dimension.

### TECHNICAL FIELD

The disclosure generally relates to the space management within a banknote processing device. In particular, the invention relates to a banknote compartment module and a banknote processing device comprising such a banknote compartment module.

### TECHNICAL BACKGROUND

Banknote processing systems are employed in a variety of applications. For example, banknote processing systems may include banknote stacking systems, banknote sorting systems, banknote singling systems, or combinations thereof. During the processing operation, these systems may acquire information about the banknotes, for example via suitable sensor systems. The sensor systems may collect the information while the banknotes are moved through the respective system. Before the banknotes are moved through the respective banknote processing system, they are usually input, for example manually, into a banknote compartment of a singler module. Starting from this banknote compartment, the banknotes are then moved through the respective banknote processing system where the banknotes are subsequently processed. Other banknote compartments may be present, for example banknote reject compartments where rejected banknotes can be stacked. However, the space within the different compartments and thus the capacity of the compartments may be limited due to constructional constraints of the overall banknote processing device. Furthermore, if the banknote processing device is opened for maintenance reasons, it may happen that some of the banknotes in the respective compartments may interact with neighboring structures and are unintentionally pushed out of the banknote compartment.

### SUMMARY

It may be seen as an object of the invention to enable a space adjustment for receiving banknotes within a banknote compartment.

According to an aspect, a banknote compartment module is provided. The banknote compartment module comprises a base unit having a support structure. The banknote compartment module further comprises a first banknote compartment coupled to the support structure of the base unit and being configured to receive a stack of banknotes. The banknote compartment module further comprises a subunit coupled to the support structure of the base unit and being arranged adjacent, e.g., in the immediate vicinity of, the first banknote compartment. The subunit is at least partially movable with respect to the first banknote compartment between a first configuration and a second configuration. The first banknote compartment provides a first space dimension for receiving the stack of banknotes within the first banknote compartment when the subunit is in the first configuration. The first banknote compartment provides a second space dimension for receiving the stack of banknotes within the first banknote compartment when the subunit is in the second configuration. The first space dimension is greater than the second space dimension.

The inventive banknote compartment module enables an adjustment of the compartment space of the first banknote compartment and, possibly, of neighboring banknote compartments based on a current fullness or stacking level of the respective banknote compartment. In particular, the banknote compartment module can adjust the compartment space within the first banknote compartment as a function of banknote stacking height currently present in the first banknote compartment. The adjustment can be carried out during operation, i.e., while the banknotes are subsequently moved out of the first banknote compartment.

In this manner, it is possible to reduce the dimensions of the first banknote compartment over time when the banknotes are moved out of the first banknote compartment, for example when the banknotes are drawn out of the first banknote compartment for singling purposes. At the same time, dimensions of the neighboring subunit, for example a further banknote compartment, can be increased as the subunit or at least parts of the subunit can move more closely towards the first banknote compartment, because the stack of banknotes within the first banknote compartment continuously becomes smaller.

The banknote compartment module may be part of a banknote processing device. The support structure of the banknote compartment module may be subdivided into several substructures defining several submodules of the banknote compartment module, for example a singler submodule, a reject submodule and a stacker submodule.

The first banknote compartment is coupled to the support structure of the base unit and may receive a stack of banknotes, i.e., several banknotes which are stacked one upon the other. The banknotes are stacked up to a specified height which may depend on a space dimension currently provided within the first banknote compartment. The first banknote compartment may be an input compartment into which a user manually inputs the stack of banknotes to be processed. In a singling process, the banknotes are subsequently moved out of the first banknote compartment to be further processed.

The banknote compartment module further comprises the subunit which is also coupled to the support structure of the base unit and which is located adjacent the first banknote compartment. The subunit or at least parts of the subunit may be moved relative to the support structure and/or relative to the first banknote compartment between the first configuration and the second configuration. In particular, a part of the subunit, e.g., a structural component of the subunit, which is arranged directly adjacent the stack of banknotes currently present within the first banknote compartment can be moved relative to the first banknote compartment, thereby changing the current space dimension of the first banknote compartment. This movement may include a rotational or pivotal movement of the part of the subunit relative to a support tray of the first banknote compartment on which the stack of banknotes within the first banknote compartment are supported. This movement may thus reduce the space dimension within the first banknote compartment as the banknotes are moved out of the first banknote compartment.

The result is that the space dimension for another neighboring unit, in this case the subunit, can be increased. In particular, if the subunit is a further banknote compartment, like for example a stacker compartment or a reject compartment, the compartment space of this further banknote compartment can be increased when the compartment space of the first banknote compartment decreases. This may be due to the movement of a part of the subunit closer towards the support tray of the first banknote compartment.

When the subunit is in the first configuration, the first banknote compartment may have its maximum space dimension for receiving banknotes and the subunit may have its minimum space dimension. Accordingly, when the subunit is in the second configuration, the first banknote compartment may have its minimum space dimension for receiving banknotes and the subunit may have its maximum space dimension. In other words, if the first banknote compartment contains less banknotes, it does need the entire space and the space dimension within the first banknote compartment can be reduced, thus providing additional space for the neighboring subunit.

The first banknote compartment may therefore provide the first space dimension for receiving a huge number of banknotes within the first banknote compartment when the subunit is in the first configuration. Accordingly, the first banknote compartment may provide the second space dimension for receiving a smaller number of banknotes within the first banknote compartment when the subunit is in the second configuration. That is, the first space dimension is greater than the second space dimension. In an example, the first space dimension may allow a stack of more than 1000 banknotes, preferably up to 1100 banknotes, to be inserted into the first banknote compartment.

It should be understood that the expression space dimension for receiving banknotes within the first banknote compartment may define a space or spatial measurement, for example a height, a width, a depth or a volume of the first banknote compartment. A height may be measured in a stacking direction of the stack of banknotes present within the first banknote compartment. The same applies to further compartments described herein.

According to an embodiment, a current space dimension provided by the first banknote compartment is dependent on a current amount of banknotes in the stack of banknotes received within the first banknote compartment.

In this manner, it is possible to adjust the current space required for receiving banknotes in the first banknote compartment to the actual amount, e.g., the number, of banknotes in the first banknote compartment. In particular, the non-occupied space in the first banknote compartment can be allocated to the neighboring subunit, i.e., by moving the subunit or parts of the subunit closer towards the first banknote compartment, for example closer to a support tray of the first banknote compartment on which the banknotes within the first banknote compartments are stacked up.

According to an embodiment, the first space dimension is defined by a first height of the stack of banknotes received within the first banknote compartment. Additionally or alternatively, the second space dimension is defined by a second height of the stack of banknotes received within the first banknote compartment.

The first height of the banknote stack in the first banknote compartment may represent a maximum height of said banknote stack, i.e., immediately after the maximum number of banknotes has been inserted by the user into the first banknote compartment. The second height of the banknote stack in the first banknote compartment may represent a height of the banknote stack which is smaller than the above-mentioned first height of the banknote stack, i.e., a stacking height which occurs after a number of banknotes has already been moved out of the first banknote compartment. In an example, the second height of the banknote stack in the first banknote compartment may represent a minimum height of the banknote stack in the first banknote compartment.

According to an embodiment, the subunit is configured to be at least partially moved from the first configuration to the second configuration, thereby reducing the first space dimension to the second space dimension.

In other words, the space dimension of the first banknote compartment may gradually or continuously become smaller during movement of the subunit, e.g., during movement of a part of the subunit like a tray component of the subunit, towards the second configuration. Having reached the second configuration, the space within the subunit may be at its maximum.

According to an embodiment, the subunit is configured to be at least partially moved from the first configuration to the second configuration as a function of a current height of the stack of banknotes received within the first banknote compartment.

In particular, the space for the subunit or within the subunit may increase when being moved from the first to the second configuration, and when the stack of banknotes within the first banknote compartment decreases. In an example, the subunit is configured to be at least partially moved from the first configuration to the second configuration as a function of the number of banknotes currently present in the first banknote compartment.

According to an embodiment, the subunit is a second banknote compartment configured to receive a stack of banknotes.

In particular, the second banknote compartment may provide a space dimension for receiving a stack of banknotes in the same manner as the first banknote compartment. For example, a support tray or tray component of the second banknote compartment may move relative to the support structure and/or relative to the first banknote compartment, such that the space dimension for receiving a stack of banknotes in the second banknote compartment increases while the space dimension for receiving a stack of banknotes in the first banknote compartment decreases, and vice versa. In this manner, it is possible to distribute space among different parts or submodules of the banknote compartment module, taking into account the current space requirements in said different parts or submodules.

According to an embodiment, the subunit provides a third space dimension for receiving a stack of banknotes within the subunit, e.g., on a tray component of the subunit, when the subunit is in the first configuration, wherein the subunit provides a fourth space dimension for receiving the stack of banknotes within the subunit, e.g., on the tray component of the subunit, when the subunit is in the second configuration, and wherein the third space dimension is smaller than the fourth space dimension.

The third space dimension for receiving the stack of banknotes within the subunit may be present at the same time when the first space dimension for receiving the stack of banknotes within the first banknote compartment is present. Accordingly, the fourth space dimension for receiving the stack of banknotes within the subunit may be present at the same time when the second space dimension for receiving the stack of banknotes within the first banknote compartment is present. This correlation will be described in more detail with respect to the figures.

According to an embodiment, the subunit comprises a tray component configured to be pivotably moved with respect to the support structure of the base unit, wherein the tray component is configured to support a stack of banknotes received within the subunit.

The stack of banknotes received within the subunit and placed on the tray component thereof may include banknotes that were originally placed in the first banknote compartment. For example, a subset or all of the banknotes moved out of the first banknote compartment for banknote processing may be forwarded to the subunit. The subunit may be a reject compartment where rejected banknotes coming from the first banknote compartment are inserted. Alternatively, the subunit may be a stacker compartment where already processed banknotes coming from the first banknote compartment are stacked up again. However, it should be understood that the subunit may be any other unit of a banknote processing device for which the provision of an adjustable space is advantageous.

According to an embodiment, the tray component is configured to be pivotably moved from a first position to a second position, thereby increasing a current space dimension for receiving banknotes within the subunit while reducing a current space dimension for receiving banknotes within the first banknote compartment.

In this manner, it is possible to adjust the space dimension in the first banknote compartment and the space dimension in the subunit to the decreasing number of banknotes in the first banknote compartment. In other words, the space which is not necessary anymore within the first banknote compartment can be shifted to the neighboring subunit, i.e., by pivotably moving the tray component closer towards the first banknote compartment, for example closer to a support tray of the first banknote compartment on which the banknotes within the first banknote compartments are or were stacked up.

According to an embodiment, the subunit comprises a biasing element configured to bias the tray component against the stack of banknotes received within the first banknote compartment.

That is, the tray component of the subunit may be pressed against the uppermost part of the banknote stack or against the uppermost banknote in the first banknote compartment such that, when the banknote stack in the first banknote compartment is getting smaller, the tray component is pushed closer to the support tray of the first banknote compartment. This exemplary embodiment may represent a passively adjusted tray component of the subunit. The biasing element may be a spring-loaded element that is configured to urge the tray component against the uppermost part of the banknote stack or against the uppermost banknote in the first banknote compartment.

According to an embodiment, the subunit comprises a drive element configured to actively initiate a pivot movement of the tray component with respect to the support structure of the base unit.

That is, the tray component may be driven by the drive component and, thus, the position and orientation of the tray component relative to the first banknote compartment may be adjusted based on a banknote stack level inside the first banknote compartment. In particular, a sensor unit may measure a current banknote stack level or current banknote stack height in the first banknote compartment and may provide this measurement to a control unit. The control unit may then control the drive unit based on the measurement, wherein the drive unit initiates and adjusts the pivot movement of the tray component. This exemplary embodiment may represent an actively adjusted tray component of the subunit, which does not necessarily require a contact between the tray component of the subunit and the uppermost part of the banknote stack within the first banknote compartment, as it would be the case for the above-described passively adjusted tray component.

According to an embodiment, the subunit comprises a flap component configured to be pivotably moved with respect to the tray component when the tray component is moved with respect to the support structure of the base unit.

In particular, the flap component may be pivotably coupled to the tray component via a hinge element. A biasing element, for example a spring-loaded element, may bias the flap component to a specified orientation with respect to the tray component. When the tray component is pivoted with respect to the support structure of the base unit, there may be a point in time when the flap component gets in contact with a further subunit, for example a further banknote compartment in which banknotes output from the banknote processing can be stacked. This further subunit may thus be arranged adjacent, e.g., in the immediate vicinity of, the subunit described above. The flap component may move, e.g., pivot, with respect to the tray component, upon contact between the flap component with this further subunit.

According to an embodiment, the first banknote compartment is a banknote singler compartment and/or the subunit is a banknote reject compartment.

The above-described further subunit may be a banknote stacking compartment or a banknote output compartment from which the banknotes can be manually withdrawn. It is noted that the subunit and the further subunit may also be other units of a banknote processing device.

According to an aspect, a banknote processing device comprising a banknote compartment module as described herein is provided. The support structure of the base unit comprises a first support substructure and a second support substructure. The subunit is coupled to the first support substructure and the first banknote compartment is coupled to the second support substructure. The first support substructure and the second support substructure are moveable relative to each other from a closed configuration to an opened configuration in order to allow access to an internal space of the banknote processing device.

The first support substructure may support a banknote reject submodule and the second support substructure may support a banknote singler submodule. The first and second support substructures may be parts of a frame-like setup of the banknote processing device. In the opened configuration, it is possible to manually access the internal space of the banknote processing device. This allows a user of the banknote processing device to carry out maintenance procedures or to rectify any malfunctions within the banknote processing device.

According to an embodiment, the subunit is configured to be at least partially moved with respect to the first support substructure when the first support substructure and the second support substructure are moved relative to each other from the closed configuration to the opened configuration.

For example, the subunit may comprise a holder component, to which the tray component is pivotably coupled. The holder component may be fixedly attached to the first support substructure. The first banknote compartment may be fixedly attached to the second support substructure. When the first support substructure is moved relative to the second support substructure to allow the access to the internal space of the banknote processing device, then the tray component will be moved relative to the first banknote compartment until the tray component contacts the stack of banknotes present in the first banknote compartment. After this contact and upon further opening the banknote processing device, the tray component may pivot with respect to the holder component, thereby enabling the banknote processing device to be further opened without any adverse interactions between the tray component and the neighboring stack of bank notes in the first banknote compartment.

### BRIEF DESCRIPTION OF THE DRAWINGS

The present invention will hereinafter be described in conjunction with the following drawing figures, wherein like numerals denote like elements, and wherein:

FIG. 1 shows a side view of an interior of a banknote processing device having a first banknote compartment and a neighboring subunit.

FIG. 2 shows a perspective view of the subunit of FIG. 1.

FIG. 3 shows a side view of the interior of the banknote processing device of FIG. 1 with the first banknote compartment providing a first space dimension.

FIG. 4 shows a side view of the interior of the banknote processing device of FIG. 1 with the first banknote compartment providing a second space dimension.

FIG. 5 shows a side view of the interior of the banknote processing device of FIG. 1 in an opened configuration, wherein a configuration of the subunit is adjusted due to the presence of a stack of banknotes in the first banknote compartment.

FIG. 6 shows a side view of the interior of the banknote processing device of FIG. 1 in an opened configuration, wherein a configuration of the subunit is adjusted due to the first banknote compartment being empty.

### DETAILED DESCRIPTION OF EXEMPLARY EMBODIMENTS

The representations and illustrations in the drawings may be schematic and not to scale. A better understanding of the banknote compartment module and the banknote processing device described above may be obtained through a review of the shown illustrations together with a review of the detailed description that follows. Throughout the Figures, same reference numerals denote the same or at least similar elements.

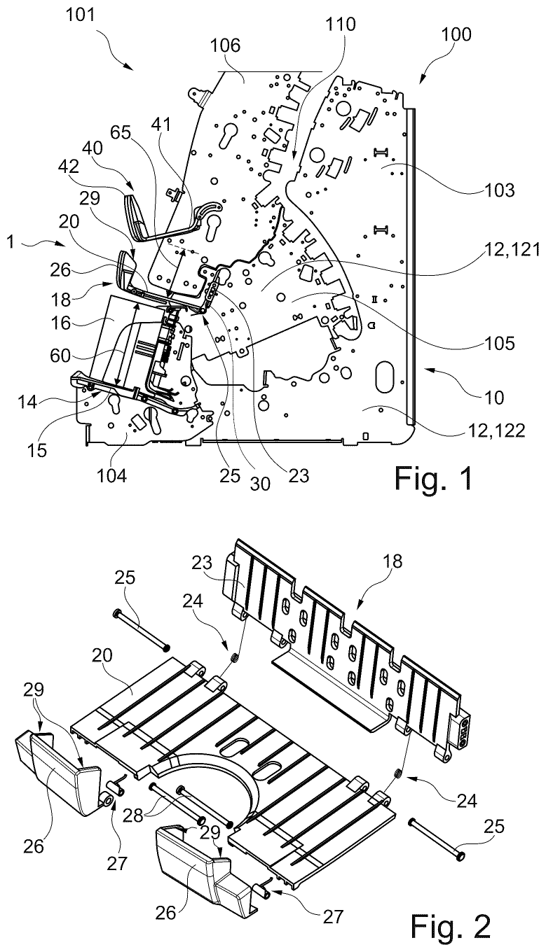

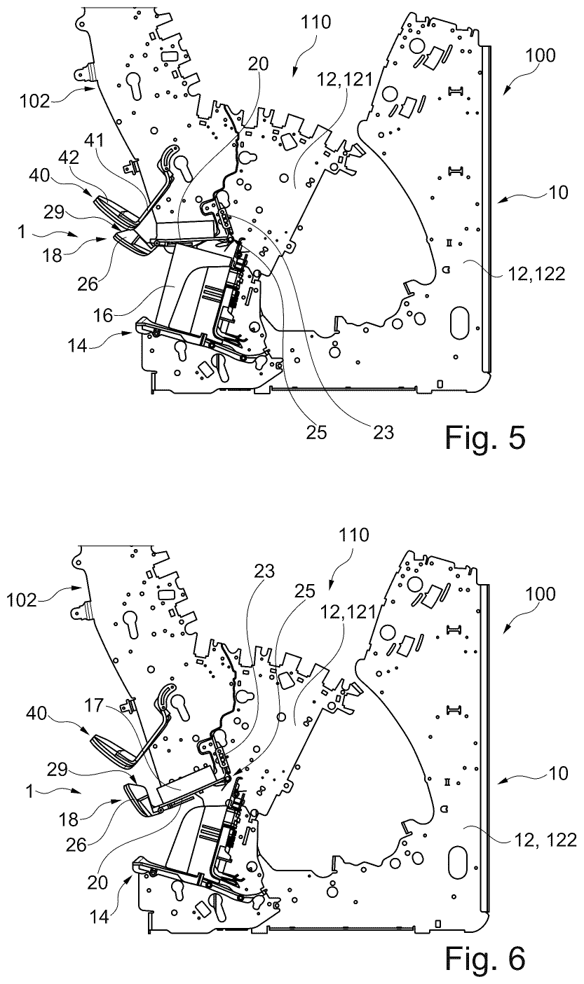

FIG. 1 shows a side view of an interior of a banknote processing device 100 having a first banknote compartment 14 and a neighboring subunit 18. The banknote processing device 100 comprises a banknote compartment module 1 having a base unit 10 with a support structure 12. The support structure 12 may comprise a first support substructure 121 and a second support substructure 122. The first support substructure 121 and the second support substructure 122 are moveable, e.g., pivotable, relative to each other from a closed configuration 101 to an opened configuration 102 (cf. FIGS. 5 and 6) in order to allow access to an internal space 110 of the banknote processing device 100. The base unit 10 may support base submodule 103 of the banknote processing device 100.

The banknote compartment module 1 basically comprises a first banknote compartment 14 and a subunit 18 which is located adjacent, in particular above, the first banknote compartment 14.

The first banknote compartment 14 is coupled to the support structure 12 of the base unit 10 and is configured to receive a stack of banknotes 16 within an internal space of the first banknote compartment 14. The banknotes 16 may be stacked onto a support tray 15 of the first banknote compartment 14. The first banknote compartment 14 may be coupled to the second support substructure 122 which may support a banknote singler submodule 104.

The subunit 18 is also coupled to the support structure 12 of the base unit 10 and is arranged adjacent the first banknote compartment 14. The subunit 18 is thus arranged in close vicinity of the first banknote compartment 14. The subunit 18 may be coupled to the first support substructure 121 which may support a banknote reject submodule 105. In particular, the subunit 18 may be coupled to the first support substructure 121 via a holder component 23 that is fixedly attached to the first support substructure 121. The subunit 18 may be a second banknote compartment comprising a tray component 20 on which a plurality of banknotes can be stacked up similar to the stacked banknotes 16 within the first banknote compartment 14. The tray component 20 may be pivotably coupled to the first support substructure 121 via a hinge element that includes pivot pins 25. The subunit 18, e.g., the second banknote compartment, may further comprise a flap component 26 which ensures that the banknotes can be stacked up on the tray component 20 of the subunit 18 without falling out of the subunit 18. The flap component 16 may be pivotably coupled to the tray component 20 and may include a free end having an inclined surface 29. The subunit 18 may further comprise a drive element 30 configured to actively initiate a pivot movement of the tray component 20 with respect to the first support substructure 121, in particular with respect to the holder component 23 that is attached to the first support substructure 121.

A current space dimension 60 can be provided by the first banknote compartment 14, wherein this current space dimension 60 may be dependent on an amount or number of banknotes 16 currently present in the stack of banknotes 16 received within the first banknote compartment 14. The current space dimension 60 may be indicative of an internal space currently available in the first banknote compartment 14 to receive banknotes 16. In particular, the current space dimension 60 may be indicative of a currently available height for stacking banknotes 16 within the first banknote compartment 14.

Similarly, a current space dimension 65 can be provided by the subunit 18, wherein this current space dimension 65 may also be dependent on an amount or number of banknotes 16 currently present in the stack of banknotes 16 received within the first banknote compartment 14 and/or a current amount or number of banknotes received within the subunit 18. It is noted that, in FIG. 1, no banknotes are shown within the subunit 18. The current space dimension 65 may be indicative of an internal space currently available in the subunit 18 to receive banknotes. In particular, the current space dimension 65 may be indicative of a currently available height for stacking banknotes within the subunit 18. It is noted that the banknote compartment module 1 may adjust or vary the currently available spaces 60 and 65 depending on a stacking height currently present in the first banknote compartment 14 and/or currently present in the subunit 18.

The banknote compartment module 1 may further comprise further or second subunit 40 which is located adjacent, in particular above, the subunit 18. The further subunit 40 may be coupled to the support structure 12 of the base unit 10 and may be configured to receive a stack of banknotes (not shown) within an internal space of the further subunit 40, for example on a support tray 41 of the further subunit 40. The further subunit 40 may also be coupled to the first support substructure 121 which may further support a banknote stacking or banknote output submodule 106. The further subunit 40 may be a third banknote compartment comprising a stopper 42 which ensures that the banknotes can be stacked up on the support tray 41 of the further subunit 40 without falling out of the further subunit 40.

FIG. 2 shows a perspective view of the subunit 18 already introduced with respect to FIG. 1. In this case, the subunit 18 is present in the form of a second banknote compartment. The subunit 18 thus includes a tray component 20 on which the banknote can be stacked up. The subunit 18 also includes a holder component 23 which is couplable to the support structure 12, in particular to the first support substructure 121 (cf. FIG. 1). The tray component 20 is pivotably coupled to the holder component 23 and thus to the support structure 12 via a hinge element that includes a pair of pivot pins 25. The subunit 18 also comprises a biasing element 24 which, in this case, includes a pair of springs, e.g., torsion springs, that urge the tray component 20 downwardly against the stack of banknotes 16 received within the first banknote compartment 14 (cf. FIG. 1). However, as noted above, the tray component 20 may also be actively driven by the drive element 30 such that the pivot movement of the tray component 20 with respect to the holder component 23 and thus with respect to the support structure 12 can be actively adjusted. The subunit 18 further comprises a flap component 26 which can be pivotably moved with respect to the tray component 20 when the flap component 26 gets in contact with the further subunit 40 via the inclined surface 29 as will be described in more detail with respect to FIG. 5. The flap component 26 may include two flaps that may be coupled to the tray component 20 via a hinge element that includes a corresponding pair of pivot pins 28. The subunit 18 comprises another biasing element 27 which, in this case, includes a pair of springs, e.g., torsion springs, that can bias the flap component 26 with respect to tray component 20.

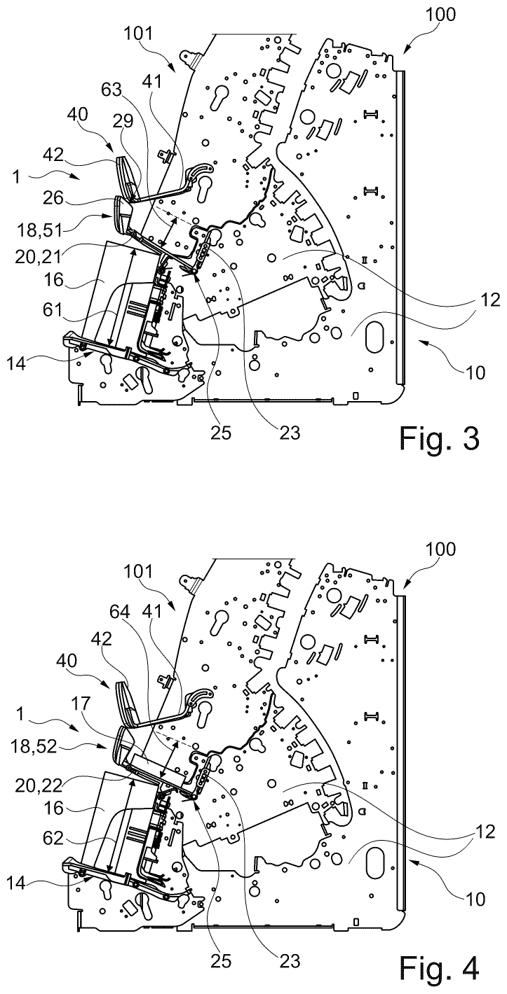

FIG. 3 shows a side view of the interior of the banknote processing device 100 of FIG. 1 with the first banknote compartment 14 providing a first space dimension 61. In the following, FIG. 3 will be contemplated together with FIG. 4 which shows a side view of the interior of the banknote processing 100 device of FIG. 1 with the first banknote compartment 14 providing a second space dimension 62. FIGS. 3 and 4 may show the interior of the banknote processing device 100 at two different times.

As indicated above, the subunit 18, in particular the tray component 20, is movable with respect to the first banknote compartment 14 between the first configuration 51 and the second configuration 52 (cf. FIGS. 3 and 4). During such a movement, the tray component 20 pivots from a first position 21 to a second position 22. As shown in FIG. 3, the first banknote compartment 14 provides a first space dimension 61 for receiving the stack of banknotes 16 within the first banknote compartment 14 when the subunit 18 is in the first configuration 51. In this situation, a large number of banknotes 16 may be present within the first banknote compartment 14 such that the tray component 20 is urged upwardly, i.e., away from the first banknote compartment 14. As there are currently no banknotes stacked onto the tray component 20 of the subunit 18, the subunit 18 does not require any additional space. The maximum possible space may thus be allocated to the first banknote compartment 14 by pivoting the tray component 20 upwardly, i.e., away from the first banknote compartment 14, such that the maximum space is made available for stacking the banknotes 16 within the first banknote compartment 14. As shown, the first space dimension 61 is defined by a first height of the stack of banknotes 16 received within the first banknote compartment 14.

Turning now to FIG. 4, the first banknote compartment 14 provides a second space dimension 62 for receiving the stack of banknotes 16 within the first banknote compartment 14 when the subunit 18 is in the second configuration 52. Compared to the situation in FIG. 3, a smaller number of banknotes 16 may be present within the first banknote compartment 14 such that the tray component 20 has moved, i.e., pivoted, towards the first banknote compartment 14. As the number of banknotes 17 stacked onto the tray component 20 of the subunit 18 increases, the subunit 18 requires additional space. More space may thus be allocated to the subunit 18 by pivoting the tray component 20 downwardly, i.e., towards the first banknote compartment 14, such that more space is made available for stacking the banknotes 17 within the subunit 18. In contrast, less space is required for the remaining banknotes 16 within the first banknote compartment 14 as the banknotes 16 are subsequently moved out of the first banknote compartment 14. As shown, the second space dimension 62 is defined by a second height of the stack of banknotes 16 received within the first banknote compartment 14. As can also be recognized from a comparison of FIGS. 3 and 4, the first space dimension 61 is greater than the second space dimension 62.

Comparing FIGS. 3 and 4 again, the subunit 18 provides a third space dimension 63 for receiving the stack of banknotes within the subunit 18 when the subunit 18 is in the first configuration 51, and the subunit 18 provides a fourth space dimension 64 for receiving the stack of banknotes 17 within the subunit 18 when the subunit 18 is in the second configuration 52, wherein the third space dimension 63 is smaller than the fourth space dimension 64.

In other words, when the tray component 20 is moved, e.g., pivoted, from the first configuration 51 to the second configuration 52, the first space dimension 61 of the first banknote compartment 14 will be reduced to the second space dimension 62 and the third space dimension of the subunit 18 will be increased to the fourth space dimension 64. The tray component 20 can particularly pivot from the first configuration 51 to the second configuration 52 as a function of a current height of the stack of banknotes 16 received within the first banknote compartment 14. As a result, the smaller the number of banknotes 16 in the first banknote compartment 14 is, the larger the space that can be allocated to the subunit 18, in this case the second banknote compartment. When the tray component 20 is pivoted upwardly starting from the configuration shown in FIG. 3, the flap component 26 will pivot outwardly as the further subunit 40 slides along the surface 29 at the free end of the subunit 18. In other words, when more banknotes 16 are stacked within the first banknote compartment 14, the subunit 40 will move upwards and the flap component 26 opens up by rotating about the respective pivot pins 27 (cf. FIG. 2). When the banknote processing begins, the overall stack height in the first banknote compartment 14 is reduced as the banknotes get singled at a speed of for example 17.5/13.3 banknotes per second. With the arrival of rejected banknotes at the subunit 18, the tray component 20 and the flap component 26 gradually rotate back to their original position (cf. FIG. 4).

FIGS. 3 and 4 show the banknote processing device 100 of FIG. 1 in a closed configuration 101 while FIGS. 5 and 6, as described in the following, show the banknote processing device 100 of FIG. 1 in an opened configuration 102.

In particular, FIG. 5 shows a side view of the interior of the banknote processing device 100 of FIG. 1 in the opened configuration 102 in which a configuration of the subunit 18 is adjusted in view of the presence of a stack of banknotes 16 in the first banknote compartment 14, whereas FIG. 6 shows a side view of the interior of the banknote processing device 100 of FIG. 1 in the opened configuration 102 in which the configuration of the subunit 18 is adjusted in view of the first banknote compartment 14 being empty.

As can be seen from FIGS. 5 and 6, the first support substructure 121 and the second support substructure 122 were moved away from each other according to a pivot movement. For example. Both support substructures 121 and 122 are coupled to each other via a hinge element. The opened configuration 102 of the banknote processing device 100 as shown in FIGS. 5 and 6 allows an access for a user, for example maintenance personnel, to the internal space 110 of the banknote processing device 100. As the subunit 18 is coupled to the first support substructure 121 and the first banknote compartment 14 is coupled to the second support substructure 122, both entities are moved relative to each other.

In the particular case of FIG. 5, the subunit 18 is moved even closer to the first banknote compartment 14. In order to avoid an adverse interference of the tray component 20 of the subunit 18 with the stack of banknotes 16 still present in the first banknote compartment 14, the tray component 20 will pivot about the hinge element 25 towards the holder component 23. This may be due to the fact that the tray component 20 is urged against the uppermost part of the stack of banknotes 16 within the first banknote compartment 14. Due to the occurring contact between the tray component 20 and the uppermost part of the stack of banknotes 16 within the first banknote compartment 14, the tray component 20 will be pushed closer towards the further subunit 40, thereby allowing the banknote processing device 100 to be even further opened, in particular without causing an adverse interference between the banknotes 16 in the first banknote compartment 14 and the tray component 20. In particular, it can be avoided that the banknotes 16 are pushed out of the first banknote compartment 14 or that the tray component 20 even breaks. The pivotal arrangement of the tray component 20 thus also reduces or eliminates the risk that banknotes 16 unintentionally fall out of the first banknote compartment 14.

What can also be seen in FIG. 5 is the interference of the flap component 26 of the subunit 18 with the further subunit 40, e.g., the third banknote compartment. In particular, the flap component 26 is coupled to the tray component 20 via the hinge element 28 as described above with respect to FIG. 2. The biasing element 27 may bias the flap component 26 at a specified orientation with respect to the tray component 20 as long as the flap component 26 is not in contact with the further subunit 40. When the free end of the flap component 26 gets in contact with the further subunit 40, for example with the stopper 42 of the further subunit 40, the flap component 26 is pivoted according to an outward movement with respect to the tray component 20. Since the free end of the flap component 26 has an inclined surface 29, as shown in FIG. 5, the further subunit 40 may advantageously slide along the surface 29 which further improves the kinematic design of the banknote processing device 100 such that disadvantageous interferences between the respective components can be avoided. It is noted that, during the opening of the banknote processing device 100, the movement of the tray component 20 towards the first banknote compartment 14 is limited or restricted by the current height of the stack of banknotes 16 within the first banknote compartment 14, as can be recognized from FIG. 5. The above-described movement of the flap component 26 relative to the tray component 20 may thus compensate for said limited or restricted movement of the tray component 20.

FIG. 6 now shows a configuration in which the banknote processing device 100 is in the opened configuration 102, but the first banknote compartment 14 is empty, i.e., has no or very few banknotes 16 stacked therein. In such a situation, the tray component 20 can freely move closer towards the first banknote compartment 14 and more space is available within the subunit 18, e.g., the second banknote compartment, for stacking up the banknotes 17. As the tray component 20 can move closer towards the first banknote compartment 14, a contact between the flap component 26 and the further subunit 40 can be avoided, thereby further avoiding possibly adverse interferences among the components of the banknote processing device 100.

1. A banknote compartment module, comprising:
a base unit having a support structure;
a first banknote compartment coupled to the support structure of the base unit and being configured to receive a stack of banknotes;
a subunit coupled to the support structure of the base unit and being arranged adjacent the first banknote compartment;
wherein the subunit is at least partially movable with respect to the first banknote compartment between a first configuration and a second configuration;
wherein the first banknote compartment provides a first space dimension for receiving the stack of banknotes within the first banknote compartment when the subunit is in the first configuration;
wherein the first banknote compartment provides a second space dimension for receiving the stack of banknotes within the first banknote compartment when the subunit is in the second configuration;
wherein the first space dimension is greater than the second space dimension.

2. The banknote compartment module of claim 1, wherein a current space dimension provided by the first banknote compartment is dependent on a current amount of banknotes in the stack of banknotes received within the first banknote compartment.

3. The banknote compartment module of claim 1, wherein the first space dimension is defined by a first height of the stack of banknotes received within the first banknote compartment; and/or
wherein the second space dimension is defined by a second height of the stack of banknotes received within the first banknote compartment.

4. The banknote compartment module of claim 1, wherein the subunit is configured to be at least partially moved from the first configuration to the second configuration, thereby reducing the first space dimension to the second space dimension.

5. The banknote compartment module of claim 1, wherein the subunit is configured to be at least partially moved from the first configuration to the second configuration as a function of a current height of the stack of banknotes received within the first banknote compartment.

6. The banknote compartment module of claim 1, wherein the subunit is a second banknote compartment configured to receive a stack of banknotes.

7. The banknote compartment module of claim 1, wherein the subunit provides a third space dimension for receiving a stack of banknotes within the subunit when the subunit is in the first configuration;
wherein the subunit provides a fourth space dimension for receiving the stack of banknotes within the subunit when the subunit is in the second configuration;
wherein the third space dimension is smaller than the fourth space dimension.

8. The banknote compartment module of claim 1, wherein the subunit comprises a tray component configured to be pivotably moved with respect to the support structure of the base unit;
wherein the tray component is configured to support a stack of banknotes received within the subunit.

9. The banknote compartment module of claim 8, wherein the tray component is configured to be pivotably moved from a first position to a second position, thereby increasing a current space dimension for receiving banknotes within the subunit while reducing a current space dimension for receiving banknotes within the first banknote compartment.

10. The banknote compartment module of claim 8, wherein the subunit comprises a biasing element configured to bias the tray component against the stack of banknotes received within the first banknote compartment.

11. The banknote compartment module of claim 8, wherein the subunit comprises a drive element configured to actively initiate a pivot movement of the tray component with respect to the support structure of the base unit.

12. The banknote compartment module of claim 8, wherein the subunit comprises a flap component configured to be pivotably moved with respect to the tray component when the tray component is moved with respect to the support structure of the base unit.

13. The banknote compartment module of claim 1, wherein the first banknote compartment is a banknote singler compartment; and/or wherein the subunit is a banknote reject compartment.

14. A banknote processing device comprising a banknote compartment module according to claim 1,
wherein the support structure of the base unit comprises a first support substructure and a second support substructure;
wherein the subunit is coupled to the first support substructure;
wherein the first banknote compartment is coupled to the second support substructure;
wherein the first support substructure and the second support substructure are moveable relative to each other from a closed configuration to an opened configuration in order to allow access to an internal space of the banknote processing device.

15. The banknote processing device of claim 14, wherein the subunit is configured to be at least partially moved with respect to the first support substructure when the first support substructure and the second support substructure are moved relative to each other from the closed configuration to the opened configuration.
